(19) United States
(12) Patent Application Publication
(10) Pub. No.: US 2007/0097978 A1
(43) Pub. Date: May 3, 2007

(54) Stream data processor

(75) Inventor: Takeharu Nakamura, Kanagawa (JP)

Correspondence Address: FOLEY AND LARDNER LLP;SUITE 500, 3000 K STREET NW, WASHINGTON, DC, 20007, US

(73) Assignee: NEC Electronics Corporation

(21) Appl. No.: 11/524,876

(22) Filed: Sep. 22, 2006

(30) Foreign Application Priority Data
Oct. 31, 2005 (JP) 2005-316484

(51) Int. Cl. H04L 12/56

(52) U.S. Cl. 370/392; 370/474

(57) ABSTRACT

A stream data processor includes a PES buffer for storing PES data, a decoder for retrieving the PES data from the PES buffer and decoding the PES data, a boundary detector for detecting a packet boundary of a PES packet of the PES data, and a packet analyzer for analyzing a PES packet header included in the stream data. The packet analyzer analyzes the packet header in response to the detection of the packet boundary. The decoder suspends retrieving the PES data from the PES buffer in response to the detection of the PES packet boundary by the boundary detector. Further, the encoder resumes retrieving the PES data from the PES buffer according to a result of the analysis of the packet header by the packet analyzer.

### BACKGROUND OF THE INVENTION

1. Field of the Invention

The present invention relates to a technology to packetize stream data, and a technology to disassemble packet of packetized stream data.

2. Description of Related Art

MPEG-2 Program Stream (PS) is formed by multiplexing a plurality of PESs (Packetized Elementary Stream) which are packetized Elementary Streams (ES) comprised of encoded audio or video data. Similarly MPEG-1 PS and MPEG-2 Transport Stream (TS) are formed by multiplexing packetized stream data. Accumulating or transmitting moving image stream data is generally carried out with packetized encoded stream data.

A configuration of a conventional stream data processor 8 for encoding and decoding a MPEG-2 PS is shown in FIG. 8. A PES buffer 811, a packet disassembler 812, an ES buffer 813, and a decoder 814 have functions for inputting PES stream data (hereinafter referred to as PES data) and outputting audio or video data encoded from the PES data.

The PES buffer 811 is a buffer memory for storing PES data. A data writing to the PES buffer 811 is executed by a PES packet demultiplxer (DEMUX) and the like for separating PES packet from MPEG-2 PS. The packet disassembler 812 inputs PES data from the PES buffer 811 and outputs ES stream data (hereinafter referred to as ES data) that is obtained by removing a PES packet header (hereinafter referred to as PES header) from the input data to the ES buffer 813. The packet disassembler 812 inputs PES data from the PES buffer 811 and shifts the PES data by one bit so as to compare with a start code indicating a start position of a PES packet to detect a start of the PES packet. The ES buffer 813 is provided between the packet disassembler 812 and the decoder 814, which operate independently, and is a buffer memory for storing ES data. The decoder 814 inputs ES data from the ES buffer 813 to decode the ES data and outputs the decoded audio or video data.

On the other hand an encoder 821, an ES buffer 822, a packetizer 823, and a PES buffer 824 have functions for inputting audio or video data and outputting packetized PES data. The encoder 821 inputs and encodes audio or video data and stores the data to the ES buffer 822 as ES data. The ES buffer 822 is provided between the encoder 821 and the packetizer 823, which operate independently, and is a buffer memory for storing ES data. The packetizer 823 inputs ES data from the ES buffer 822, inserts a PES header to a boundary of a PES packet to generate PES data, and outputs the generated PES data to the PES buffer 824. A position to insert the PES header is determined by matching data input from the ES buffer 822 with a special code embedded in the ES data for locating header inserting position. The PES data stored to the PES buffer 824 is multiplexed with other PES data and output as MPEG-2 PS.

A technique to efficiently packetizing stream data or disassemble packetized stream data with the abovementioned stream data processor has been suggested (for example a technique disclosed in Japanese Unexamined Patent Application Publication No. 11-317765).

A packetizing apparatus for encoding and packetizing stream data is disclosed in Japanese Unexamined Patent Application Publication No. 11-317765. The packetizing apparatus includes an encoding apparatus, a stream length calculating apparatus, and a header adding apparatus. The encoding apparatus inputs and encodes video or audio data and outputs the encoded stream data. The encoding apparatus further attaches a flag bit representing a packet header inserting position to the stream data. The stream length calculating apparatus identifies the packet header inserting position from a value of the flag bit attached to the encoded stream data and calculates stream data length (i.e. stream length) from an interval of the flag bit. Further, the stream length calculating apparatus outputs the calculated stream length to the header adding apparatus and outputs the flag bits attached to the encoded stream data to a recording medium. The header adding apparatus reads out the encoded stream data from the recording medium and inserts a packet header to the packet header inserting position located by the flag bit so as to generate a packetized stream data. The packet header to be inserted is generated in reference to the stream length calculated by the stream length calculating apparatus. As described in the foregoing, the packetizing apparatus disclosed in Japanese Unexamined Patent Application Publication No. 11-317765 outputs flag bits attached to stream data and identifies header inserting position by the flag bits. This eliminates the need for a match to detect the special code embedded in the stream data, thereby simplifying packetizing processes.

Furthermore, Japanese Unexamined Patent Application Publication No. 2004-120632 discloses a PES packet demultiplexer. The PES packet demultiplexer enables to efficiently perform a header analysis that is necessary for demultiplexing stream from MPEG-2 PS. To be specific, the demultiplexer matches a received stream data with a start code representing a start position of a packet, which is a start position of a header. Then a starting timing to analyze a packet header to obtain information including header length, packet length, and stream ID, the packet header analysis process is delayed till completing to receive data of a specified bytes after detecting the start code. This enables to start analyzing while main data comprising the header are stored to a buffer. It therefore reduces the number of accesses to the buffer and promotes efficiency in the analysis process. In case data comprising a PES packet is evaluated to be a video stream by the packet header analysis, the PES packet is stored to a PES buffer for a video decoder. While the PES packet is evaluated to be an audio stream, the PES packet is stored to a PES buffer for an audio decoder.

The stream data processor 8 and the apparatuses disclosed in Japanese Unexamined Patent Application Publication No. 11-317765 and 2004-120632 includes a buffer memory (such as the ES buffer 813 and 822) between a packet disassembler and a decoder or between an encoder and a packetizer so as to temporarily stores ES data.

However it has now been discovered that providing a buffer memory between a packet disassembler and a decoder or between an encoder and a packetizer causes to increase the number of memory accesses, thereby preventing to improve processing capability of a stream data processor.

### SUMMARY OF THE INVENTION

According to an aspect of the present invention, there is provided a stream data processor that includes a buffer for storing stream data formed by a plurality of packets, a decoder for retrieving the stream data from the buffer and decoding the stream data, a boundary detector for detecting a packet boundary of the stream data, and a packet processor for analyzing a packet header included in the stream data. The decoder suspends retrieving the stream data from the buffer in response to the detection of the packet boundary by the boundary detector. The packet processor analyzes the packet header in response to the detection of the packet boundary by the boundary detector. Further, the decoder resumes retrieving the stream data from the buffer according to a result of the analysis of the packet header by the packet processor.

In case packetized stream data is PES data in compliance with MPEG-2 standard, it is possible to sequentially read PES data and directly decode the PES data and suspend retrieving PES data to be decoded when reading data reaches a packet boundary so as to perform a packet analysis process for separating PES header from the PES data. After the packet analysis process, PES data can be sequentially read out to be directly decoded.

In contrast to a conventional technique, instead of separating a packet assembly process for separating PES header from PES data and a decoding process for getting ES data, two processes can be synchronously processed or integrated in the present invention. This eliminates the needs for the ES buffer 813 provided between the packet disassembler 812 and the decoder 814 to temporarily store stream data. Accesses to the ES buffer 813 are also not necessary, thereby promoting efficiency in packet disassembling and decoding processes of the PES data.

According to another aspect of the present invention, there is provided a stream data processor that includes a buffer for storing stream data formed by a plurality of packets, an execution unit for executing a first instruction program defining a process to retrieve and decode the stream data from the buffer and a second instruction program defining an analysis process of a packet header included in the stream data, and a boundary detector for detecting a packet boundary of the stream data read from the buffer. The boundary detector generates an interruption request to the execution unit in response to the detection of the packet boundary. The execution unit branches from the first instruction program to the second instruction program in response to the interruption request and resumes the first instruction program according to a result of the analysis process of the packet header after completing the second instruction program.

In contrast to a conventional technique, instead of separating a packet assembly process for separating PES header from PES data and a decoding process for getting ES data, two processes can be synchronously processed or integrated in the present invention. This eliminates the needs for the buffer memory provided between the packet disassembling process and the decoding process, thereby promoting efficiency in packet disassembling and decoding processes of the PES data.

According to another aspect of the present invention, there is provided a stream data processor that includes a buffer for storing stream data formed by a plurality of packets, an encoder for outputting stream data with encoded input signal to the buffer, a packet processor for generating a packet header to be inserted to the stream data, and a boundary detector for detecting an inserting position of the packet header in the stream data. The encoder suspends outputting the stream data to the buffer in response to the detection of the insertion position of the packet header. The packet processor outputs the packet header to the buffer in response to the detection of the insertion position of the packet header. Further, the encoder resumes outputting the stream data to the buffer after the packet processor completes outputting the packet header.

In case packetized stream data is PES data in compliance with MPEG-2 standard, it is possible to sequentially encode input signal to ES data, directly output the ES data to the PES buffer and suspend outputting ES data when outputting data reaches a packet boundary so as to write a PES header to the PES buffer. After the PES header insertion process, ES data can be sequentially output to the PES buffer directly.

In contrast to a conventional technique, instead of separating an encoding process for generating ES data and a packetizing process for inserting a PES header to the ES data to obtain PES data, two processes can be synchronously processed or integrated in the present invention. This eliminates the needs for the ES buffer 822 provided between the encoder 821 and packetizer 823 to temporarily store stream data. Accesses to the ES buffer 822 are also not necessary, thereby promoting efficiency in encoding and packetizing processes to generate the PES data.

According to another aspect of the present invention, there is provided a stream data processor comprising, a buffer for storing stream data formed by a plurality of packets, an execution unit for executing a first instruction program defining a process to output stream data with encoded input signal to the buffer and a second instruction program defining a process to generate a packet header and insert the packet header to the stream data, and a boundary detector for detecting an insertion position of the packet header to the stream data. The boundary detector generates an interruption request to the execution unit in response to the detection of the inserting position of the packet header. The execution unit branches from the first instruction program to the second instruction program in response to the interruption request and resumes the first instruction program after completing the second instruction program.

In contrast to a conventional technique, instead of separating an encoding process for generating ES data and a packetizing process for inserting a PES header to the ES data to obtain PES data, two processes can be synchronously processed or integrated in the present invention. This eliminates the needs for the buffer memory provided between the encoding process and packetizing process, thereby promoting efficiency in encoding and packetizing processes to generate the PES data.

The present invention prevents from deteriorating processing efficiency due to buffer memory accesses in case of disassembling and decoding packets of packetized stream data or encoding and packetizing to generate packetized stream data.

### BRIEF DESCRIPTION OF THE DRAWINGS

The above and other objects, advantages and features of the present invention will be more apparent from the following description taken in conjunction with the accompanying drawings, in which:

FIG. 1 is a functional block diagram showing a stream data processor according to the present invention;

FIG. 2 is a configuration example of the stream data processor according to the present invention;

FIG. 3 is a pattern diagram explaining an operation of a packet analysis as an interruption process;

FIG. 4 is a flowchart showing an operation of a data processor according to the present invention;

FIG. 5 is a functional block diagram showing a stream data processor according to the present invention;

FIG. 6 is a flowchart showing an operation of a data processor according to the present invention;

FIG. 7 is a functional block diagram showing a stream data processor according to the present invention; and

FIG. 8 is a functional block diagram showing a stream data processor according to a conventional technique.

### DESCRIPTION OF THE PREFERRED EMBODIMENTS

The invention will be now described herein with reference to illustrative embodiments. Those skilled in the art will recognize that many alternative embodiments can be accomplished using the teachings of the present invention and that the invention is not limited to the embodiments illustrated for explanatory purposes.

In the drawings, components identical are denoted by reference numerals identical to those therein with detailed description omitted as appropriate. Embodiments described hereinafter include a stream data processor for disassembling a PES packet in compliance with MPEG-2 standard and a stream data processor for generating a PES packet to which the present invention is applied.

### First Embodiment

FIG. 1 is a functional block diagram showing a stream data processor 1 of this embodiment. The stream data processor 1 inputs PES data from a PES packet demultiplexer (not shown) for demultiplexing MPEG-2 PS to a plurality of PES data, disassembles and decodes PES packets, and outputs decoded audio or video data.

The PES buffer 11 is a buffer memory for storing PES data input from an external PES packet demultiplexer and the like. A decoder 12 includes a data retriever 13 and a decoding unit 14. The data retriever 13 sequentially retrieves PES data from the PES buffer 11 and outputs retrieved PES data to the decoding unit 14. The decoding unit 14 decodes data input from the data retriever 13 in compliance with MPEG-2 standard and outputs audio or video data.

The data retriever 13 needs to output payload part of the PES packet without PES header, which is ES data, to the decoding unit 14. Accordingly the stream data processor 1 detects an end of the payload of the PES packet by a boundary detector 15 while the data retriever 13 is sequentially reading the PES data from the PES buffer 11. The data retriever 13 suspends outputting PES data to the decoding unit 14 in response to the detection. Therefore the data retriever 13 is capable of outputting only the payload part of a PES packet to the decoding unit 14, leaving PES header.

Firstly the data retriever 13 increments or decrements a value of a PES counter 16 for a value corresponding to a data length of PES data obtained from the PES buffer 11. The boundary detector 15 monitors the value of the PES counter 16. The boundary detector 15 directs the data retriever 13 to suspend reading PES data when the PES counter 16 reaches a specified value.

Specifically, the PES counter 16 stores a value corresponding to a payload length of a PES packet to start reading therefrom. Then the data retriever 13 starts decrementing the counter value of the PES counter 16 from when it started retrieving a first payload data of the PES packet. This operation makes it possible to determine that the data retriever 13 completed reading a payload part of a PES packet and a boundary of the packet has been reached by the counter value of the PES counter 16 becoming 0.

The boundary detector 15 directs a packet analyzer 17 to perform packet analysis when the boundary detector 15 determines that the data retriever 13 reached a boundary of a PES packet while reading PES data.

The packet analyzer 17 analyzes a PES header including to obtain PES packet and header lengths. The packet analyzer 17 reads PES data from the PES buffer 11 starting from the position where the data retriever 13 suspended reading data, determines that the data reading out is PES header by matching the data with a start code, and obtains information regarding PES packet length and PES header length from the PES header read out. Other PES header information including PTS (Presentation Time Stamp) and DTS (Decoding Time Stamp) may be obtained together at this time.

The packet analyzer 17 calculates a payload size of a PES packet from PES packet length and header length and sets the calculated value to the PES counter 16. The packet analyzer 17 updates a read address of the data retriever 13 for the data retriever 13 to resume reading from the start position of a payload of a PES packet. For example a value of a register (not shown) for storing the read address of the data retriever 13 can be incremented for the value corresponding to the PES header length.

After that, the packet analyzer 17 notifies the data retriever 13 to resume reading data and outputting data to the decoding unit 14. This enables the data retriever 13 to output only ES data to the decoding unit 14.

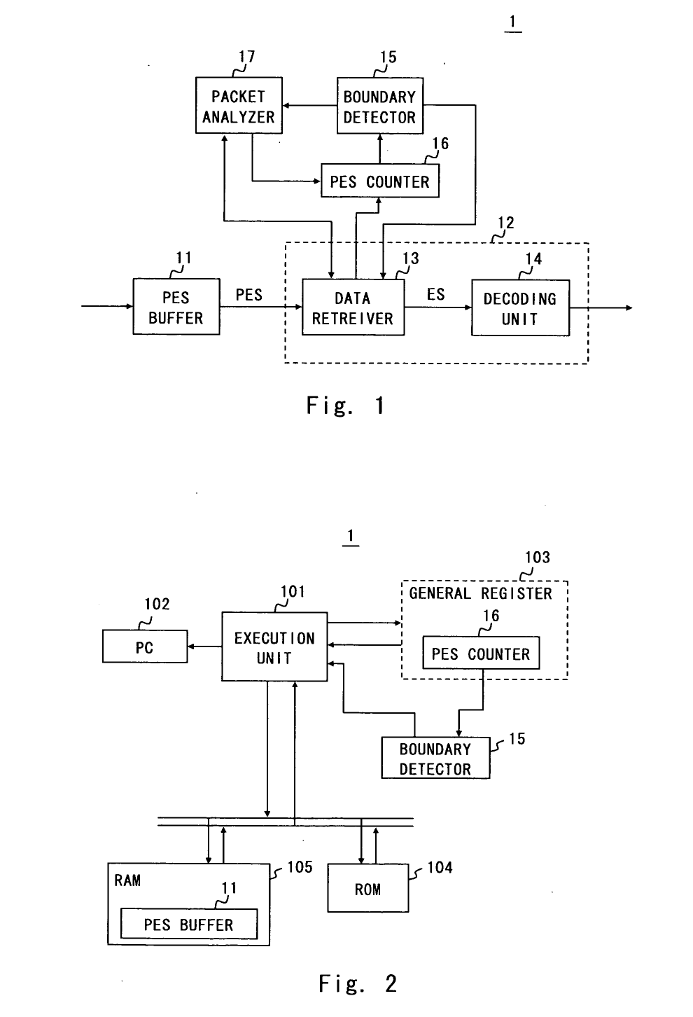

The stream data processor 1 shown in FIG. 1 maybe formed by a processor system having a processor that executes a program. FIG. 2 is a view showing an example of the stream data processor 1 formed by a processor system. The execution unit 101 is a processor for fetching instructions from a ROM 104 or RAM 105 to execute the instructions. A program counter 102 stores an address of an instruction executed by the execution unit 101. A value of the program counter 102 is updated by the execution unit 101. The value of the program counter 102 is updated by a value corresponding to an instruction length while instructions are sequentially executed. However in case of an interruption occurred, the value of the program counter 102 is discontinuously updated by an interruption instruction.

A general register 103 is a register group used for operations in the execution unit 101. In FIG. 2, a part of the general register 103 is used as the PES counter 16. Further in FIG. 2, a part of the RAM 105 is used as the PES buffer 11. A register exclusive for, the general register 13 may be provided so as to prevent the PES counter 16 to be updated unexpectedly, instead of assigning a part of the general register 103 to be the PES counter 16.

The execution unit 101 executes a program for sequentially executing LOAD instruction, corresponding to a data reading process from the PES buffer 11 by the data retriever 13, as long as there is no interruption occurred. While executing the LOAD instruction, the value of the PES counter 16 is decremented for data length of the data to be read out. The boundary detector 15 monitors the value of the PES counter 16 and sends an interruption request to the execution unit 101 when the value becomes 0. The execution unit 101 that has received the interruption request branches to a program for executing packet analysis performed by the packet analyzer 17.

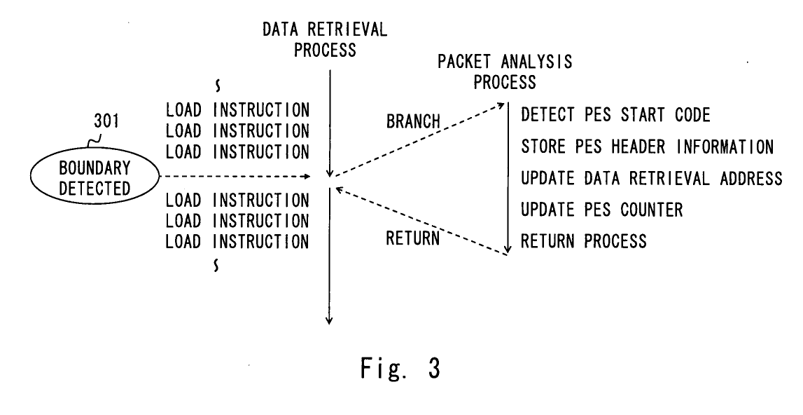

FIG. 3 is a conceptual view showing an interruption process that branches a process of the execution unit 101 from a data retrieval process to a packet analysis process with a detection of a packet boundary as an interruption factor. As shown in FIG. 3, when the boundary detector 15 detects a packet boundary (boundary detection 301) while sequentially executing LOAD instructions in data retrieval process, the boundary detector 15 generates an interruption. The execution unit 101 suspends the data retrieval process in response to the interruption and branches to a packet analysis process.

In the branched packet disassembly process as stated above, a PES start code is detected to find a start position of a PES header, PES header information such as PES header length and PES packet length are obtained, and the value of the PES counter 16 is set to a payload length of the PES packet. Further, a value of an address register to be referenced by a LOAD instruction when returning to the data retrieval process is incremented by the data length corresponding to the PES header length. For example, suppose that the value of the address register before moving to the packet analysis process is X and a packet header length including a start code is 64 bits. In this case, the value of the address register is updated to X+64. After the packet analysis process, restore the values of the program counter 102 and the general register 103 excluding the above address register to the values before the suspension and return to the data retrieval process.

In FIGS. 2 and 3, a process of the decoding unit 14 is simplified for ease of explanation. The decoding process may be performed by the execution unit 101. Alternatively hardware for decoding may be provided.

As shown in FIG. 3, packet analysis process can be executed as an interruption process by the stream data processor 1 formed by a processor system generating an interruption to the execution unit 101 in response to a detection of a packet boundary by the boundary detector 15. This eliminates the needs for the execution unit 101 to detect packet boundary, thereby reducing load on the execution unit 101 and increasing efficiency in data retrieval and other processes.

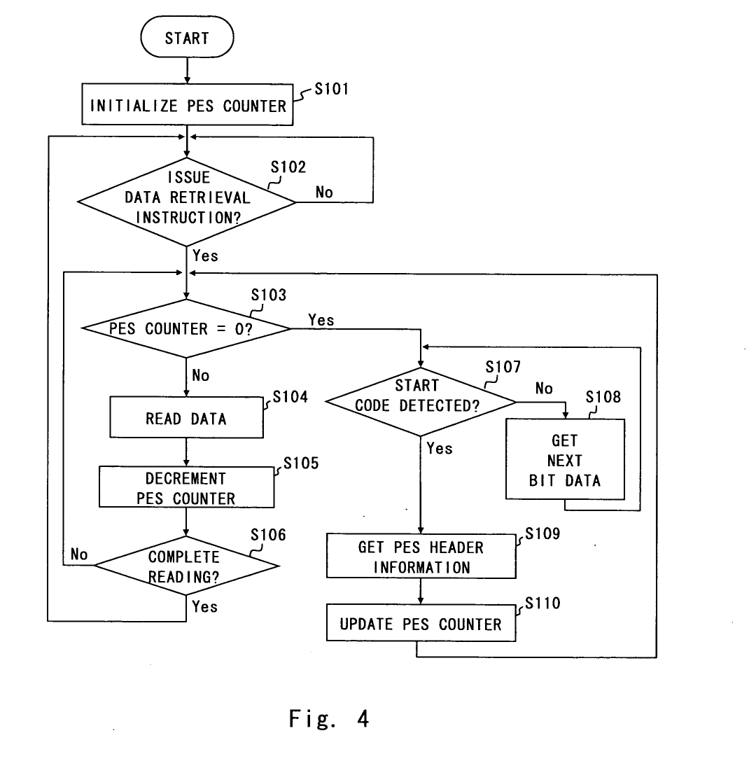

FIG. 4 is a flowchart showing a process of the stream data processor 1 to retrieve PES data and disassemble packet. The PES counter 16 is initialized in step S101. The initialization here indicates that the boundary detector 15 sets the value of the PES counter 16 to a value that the boundary detector 15 determines to be a boundary of a PES packet. In the explanation below, the value of the PES counter 16 corresponding the packet boundary is 0, and the counter value is set to 0 in initialization. The PES counter 16 is initialized because in the beginning of retrieving PES data, a header analyzer 17 needs to recognize a PES header. By the initialization of the PES counter 16, steps S107 and S108 described later can be executed unconditionally so as to find a PES header by detecting a start code.

In step S102, determine whether an instruction for executing a process of the data retriever 13 such as abovementioned LOAD instruction (hereinafter referred to as data retrieval instruction) is issued or not. In case a data retrieval instruction is issued, steps following S102 are executed.

In step S103, the value of the PES counter 16 is evaluated whether the value is 0. This evaluation corresponds to a process by the boundary detector 15. In case the PES counter 16 is evaluated to be not zero, steps S104 to S106 are executed.

In the step S104, PES data is read from the PES buffer 11. PES data should be read at a certain unit such as 1 bit or byte. In step S105, the value of the PES counter 16 is decremented in proportion to the size of the PES data being read out. In step S106, it is evaluate whether data for the number of data specified by the data retrieval instruction has been read. When data for the specified number is read from the PES buffer 11, return to step S102. In case the data reading is not completed, return to step S103.

In case the value of the PES counter 16 is evaluated to be 0 in step S103, steps S107 to S110 are executed. These processes correspond to a process of the packet analyzer 17. In step S107, data read from the PES buffer 11 is evaluated to match a start code that represents a start position of a PES packet. In case the data does not match with the start code, next bit is read from the PES buffer 11 (step S108) and repeats matching with the start code. When the start code is detected, data corresponding to PES header is read from the PES buffer 11 and PES header information including PES header length and packet length are obtained (step S109). In step S110, the value of the counter 16 is updated by a payload length of a PES packet calculated according to the PES header length and packet length. Then return to step S103.

As described in the foregoing, the stream data processor 1 of this embodiment sequentially reads PES data from the PES buffer 11 and outputs the PES data to the decoding unit 14. In case the PES data being read is a PES header, outputs to the decoding unit 14 is suspended and the PES header is analyzed by the packet analyzer 17. This enables only a payload part of a PES packet without PES header to be output to the decoding unit 14.

In other words in the stream data processor 1, the decoder 12 reads and decodes payload part of PES data using payload length information obtained by the packet analyzer 17 in the analysis process. The stream data processor 1 is characterized by associating a header analysis process by the header analyzer 17 and the decoding process by the decoder 12. This eliminates the need for a buffer memory required to separate a packet disassembly process and decoding process, as with the ES buffer 813 provided between the packet disassembler 812 and the decoder 814 of the conventional stream processor 8. The stream data processor 1 of this embodiment therefore does not require memory accesses to the ES buffer, thereby improving efficiency in packetizing and decoding processes of PES data.

The stream data processor 1 stores the payload size of the PES packet calculated from the PES packet and header lengths included in the PES header. The stream data processor 1 is capable of evaluating whether data read from the PES buffer 11 reaches a boundary of a PES packet by the data retriever 13 reading PES data for one packet. In other words the stream data processor 1 detects a packet boundary according to PES packet length information obtained from the PES header and a number of data read by the data retriever 13. This eliminates the needs for matching with a start code representing a PES header to detect a packet boundary except for the processes of retrieving PES data and recognizing PES header. Therefore amount of processes required for disassembling packet can be reduced.

### Second Embodiment

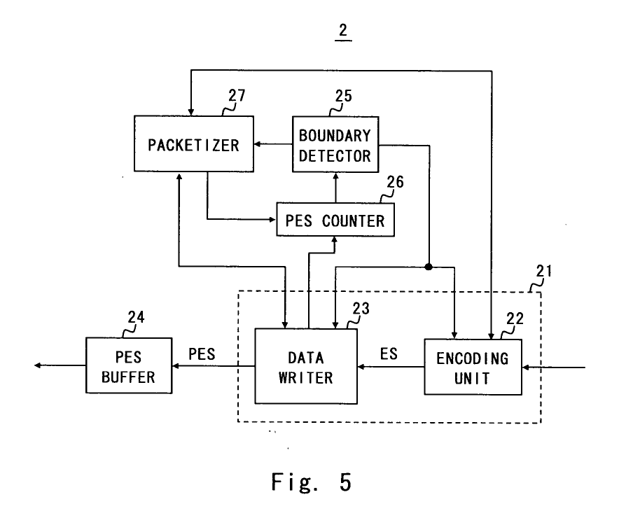

FIG. 5 is a functional block diagram showing a stream data processor 2 of a second embodiment. The stream data processor 2 inputs and encodes audio or video data, packetizes the encoded ES data, and outputs PES data.

The encoder 21 includes an encoding unit 22 and a data writer 23. The encoding unit 22 inputs video or audio data and encodes in compliance with MPEG-2 standard. The data writer 23 inputs ES data encoded by the encoding unit 22 and stores the ES data by a certain unit such as 1 bit or byte to a PES buffer 24.

The data writer 23 is required to insert a PES header to the ES data output to the PES buffer 24 and stores the data to the PES buffer 24 as PES data. The streaming data processor 2 detects timing by the boundary detector 25 to insert the PES header into the data to be stored to the PES buffer 24. An ES data output by the encoding unit 22 and an output to the PES packet buffer 24 by the data writer 23 are suspended in response to the detection.

The data writer 23 decrements or increments the value of the PES counter 26 for a value corresponding to a data length of the ES data received from the encoding unit 22 or a data length output to the PES buffer 24. The boundary detector 25 monitors the value of the PES counter 26. When the PES counter 26 reaches a specified value, the encoding unit 22 and the data writer 23 are suspended their processes.

To be specific, a size of a payload of a PES packet output to the PES buffer 24 by the data writer 23 is stored to the PES counter 26. Then the data writer 23 starts decrementing the value of the PES counter 26 at a timing when the data writer 23 starts writing ES data, which is the beginning of the payload of the PES packet. This makes it possible to determine that a payload part of a PES packet is completed to be written by the data writer 23 and a packet boundary to insert a PES header is reached by the value of the PES counter 26 becoming zero.

The boundary detector 25 directs a packetizer 27 to insert a PES header when the boundary detector 25 determines that the data writer 23 reached a boundary of a PES packet while writing data.

In response to the instruction by the boundary detector 25, the packetizer 27 directs the data writer 23 to write the PES header. A PES packet length included in the PES header is calculated by the encoding unit 22 or provided as a specified value such as a user-specified value. Information such as DTS and PTS is calculated by the encoding unit 22. The packetizer 27 sets a PES payload size to the PES counter 26.

The packetizer 27 directs the encoding unit 22 and the data writer 23 to resume processing after the abovementioned process is completed.

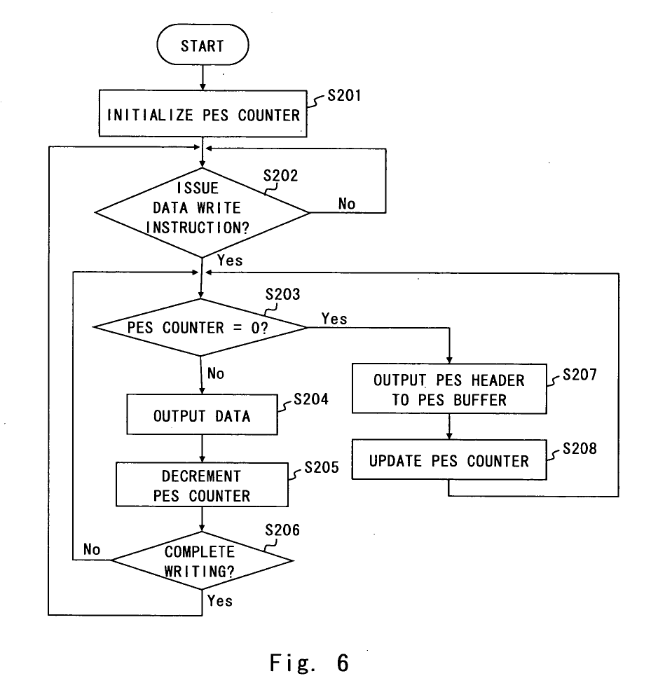

FIG. 6 is a flowchart showing a packetizing process that the stream data processor 2 performs. In step S201, the PES counter 26 is initialized. The initialization here indicates that the PES counter 26 is set a value that the boundary detector 25 evaluates to be a boundary of a PES packet. In the explanation below, the value of the PES counter 26 corresponding the packet boundary is 0, and the counter value is set to 0 in the initialization. In step S202, determine whether an instruction for executing a process of the data writer 23 such (hereinafter referred to as data write instruction) is issued or not. In case a data write instruction is issued, steps following S202 are executed.

In step S203, the value of the PES counter 26 is evaluated whether the value is 0. This evaluation corresponds to a process by the boundary detector 25. In case the PES counter 26 is evaluated to be not zero, steps S204 to S206 are executed.

In the step S204, the data writer 23 outputs the ES data generated by the encoding unit 22 to the PES buffer 24. ES data should be written at a certain unit such as 1 bit or byte. In step S205, the value of the PES counter 26 is decremented in proportion to the size of the data stored to the PES buffer 24. In step S206, it is evaluate whether data for the number of data specified by the data write instruction has been written. When data for the specified number is written to the PES buffer 24, return to step S202. In case the data writing is not completed, return to step S203.

In case the value of the PES counter 26 is evaluated to be 0 in step S203, steps S207 to S208 are executed. These processes correspond to a process of the packetizer 27. In step S207, the PES header is output to the PES buffer 24. In step 208, the value of the PES counter 26 is set to a data length of a payload of the PES packet, then return to step S203.

The stream data processor 2 of this embodiment sequentially stores ES data encoded by the encoder 21. However when the stream data processor 2 determines a timing to insert a PES packet according to a write data length to the PES buffer 24, the encoder 21 suspends its process, and the packetizer 25 stores the PES header to the PES buffer 24.

Associating the encoding and packetizing processes eliminates the need for the ES buffer 882 provided between the encoder 821 and the packetizer 823 in the conventional stream processor 8. This reduces the number of memory accesses and promotes efficiency in encoding and packetizing processes for generating PES data.

The stream data processor 2 stores the payload size of the PES packet. Whether the packet boundary to insert the PES header is reached is determined by detecting that the data writer 23 output ES data storable to a payload for one packet or the encoding unit 22 generated ES data storable to a payload of one packet. Specifically, the stream processor 2 is to detect the packet boundary according to the PES packet information obtained from the encoding unit 22 and the like and write-data length by the data writer 23.

This eliminates the needs for matching with a special coded included in the ES data to detect the packet boundary and finding the PES header inserting position, thereby reducing an amount of processes required for packetizing. Further, it is not required to attach a flag bit to the ES data as with the packetizing apparatus disclosed in Japanese Unexamined Patent Application Publication No. 11-317765. Accordingly a bit rate to transfer the flag bit does not increase and memory area to store the flag bit is not necessary.

Further, the stream data processor 2 may be formed by a processor system as with the stream data processor 1. Specifically, in response to a detection of a packet boundary by the boundary detector 25, an interruption is generated in the execution unit 101 to perform the packetizing process as an interruption process to the encoding process. This eliminates the needs for the execution unit 101 to detect the packet boundary, thereby reducing load on the execution unit 101 and promoting efficiency in encoding processes including data write.

### Third Embodiment

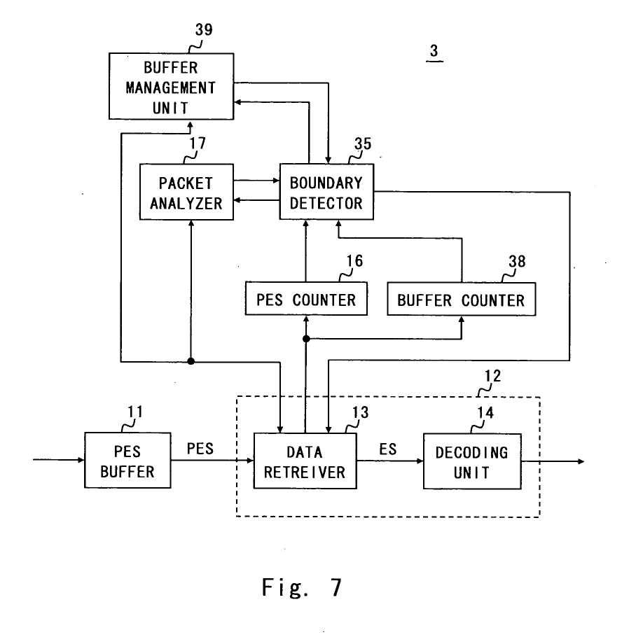

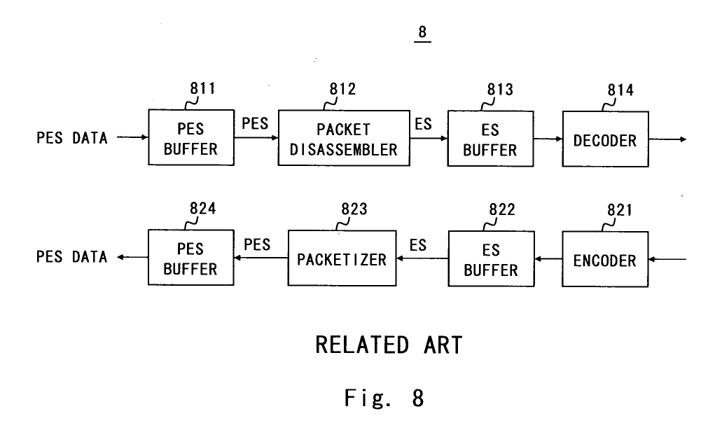

FIG. 7 is a functional block diagram showing a stream data processor 3 of this embodiment. The stream data processor 3 performs a process to detect another boundary in addition to a process to detect a boundary of a PES packet that the stream data processor 1 of the first embodiment performs. FIG. 7 is a view showing a configuration to detect a buffer boundary and perform buffer management, as an example of detecting another boundary.

There are several buffer management methods. A method to manage a plurality of finite-length buffers using a linked list so as to use them as one PES buffer 11 is described hereinafter. In the linked list, finite-length buffers are linked by pointers.

A buffer counter 38 stores remaining data of the finite-length buffers that are currently processed. For example by specifying an initial value of the buffer counter 38 to a maximum number of data storable to a finite-length buffer to be processed, an end of the current finite-length buffer can be evaluated to have reached to an end by the value of the buffer counter 38 becoming 0. Accordingly a boundary detector 35 suspends the process of the data retriever 13 when detecting that the buffer counter 38 is 0, and directs a buffer management unit 39 to perform buffer management.

The buffer management unit 39 accesses the finite-length buffer that has reached to its end and reads a pointer to the next finite-length buffer. The pointer is stored as the last data of the finite-length buffers. The pointer indicates a first address of the next finite-length buffer and a storable data size. The buffer management unit 39 refers to pointer information and sets the number of data storable to the next finite-length buffer to the buffer counter 38. After that, the buffer management unit 39 notifies the data retriever 13 to resume reading PES data.

The stream data processor 3 may be formed by a processor system as with the stream data processor 1 described above. The process of the buffer management unit 39 can be performed as an interruption process to the data retrieval process as with the packet analysis process. It is possible that an interruption request to interrupt the process of the buffer management unit 39 and an interruption request to interrupt the packet analysis process may occur at the same time. In such a case, a known multiple interruption technique may be applied. To be specific, interruptions can be controlled to prioritize a process having a higher priority. In this embodiment, the process of the buffer management unit 39 is prioritized to the packet analysis process.

As described in the foregoing, the stream data processor 3 suspends obtaining PES data in case a plurality of other processes such as packet disassembly and buffer management need to be executed depending on the number of data to be processed so as to process the plurality of other processes.

In the embodiments above, boundaries of a PES packet and a buffer are indicated as a boundary of stream data. However other data position may be detected by the boundary detector. In case other processes need to be executed depending on the number of processes while processing stream data in a specified unit such as a bit or byte, a data position to move to other processes may be detected by the boundary detector.

The embodiments above concern apparatuses for processing MPEG-2 PES data. However the present invention is not restricted to this but is broadly be effective to process packetized stream data.

It is apparent that the present invention is not limited to the above embodiment and it may be modified and changed without departing from the scope and spirit of the invention.

What is claimed is:

1. A stream data processor comprising:
a buffer for storing stream data formed by a plurality of packets;
a decoder for retrieving the stream data from the buffer and decoding the stream data;
a boundary detector for detecting a packet boundary of the stream data; and
a packet processor for analyzing a packet header included in the stream data,
wherein the decoder suspends retrieving the stream data from the buffer in response to the detection of the packet boundary,
the packet processor analyzes the packet header in response to the detection of the packet boundary, and
the decoder resumes retrieving the stream data from the buffer according to a result of the analysis of the packet header.

2. The stream data processor according to claim 1,
wherein the packet processor determines a data length of data to be decoded by the decoder according to information included in the packet header, and
the detection of the packet boundary by the boundary detector is performed by the decoder counting the data length retrieved from the buffer and determining that the count value reached the data length to be encoded.

3. The stream data processor according to claim 1, wherein the packet processor updates a read address of the buffer so that the decoder skips the packet header in case of resuming to retrieve the stream data.

4. A stream data processor comprising:
a buffer for storing stream data formed by a plurality of packets;
an execution unit for executing a first instruction program defining a process to retrieve and decode the stream data from the buffer and a second instruction program defining an analysis process of a packet header included in the stream data; and
a boundary detector for detecting a packet boundary of the stream data read from the buffer,
wherein the boundary detector generates an interruption request to the execution unit in response to the detection of the packet boundary, and
the execution unit branches from the first instruction program to the second instruction program in response to the interruption request and resumes the first instruction program according to a result of the analysis process of the packet header after completing the second instruction program.

5. The stream data processor according to claim 4, wherein the analysis process of the packet header defined in the second instruction program includes a process to update a read address of the buffer referenced by the first instruction program based on a data length of the packet header being analyzed so that data is retrieved from the buffer skipping the packet header in case, of resuming the decoding process defined by the first instruction program.

6. A stream data processor comprising:
a buffer for storing stream data formed by a plurality of packets;
an encoder for outputting stream data with encoded input signal to the buffer;
a packet processor for generating a packet header to be inserted to the stream data; and
a boundary detector for detecting an inserting position of the packet header in the stream data,
wherein the encoder suspends outputting the stream data to the buffer in response to the detection of the insertion position of the packet header,
the packet processor outputs the packet header to the buffer in response to the detection of the insertion position of the packet header, and
the encoder resumes outputting the stream data to the buffer after the packet processor completes outputting the packet header.

7. The stream data processor according to claim 6,
wherein the packet processor determines a data length of stream data included in one packet that is specified by a packet header the packet processor inserts based on information retrieved from the encoder, and
the detection of the insertion position of the packet header by the boundary detector is performed by counting the data length output to the buffer by the encoder and evaluating that a count value reached the data length of the stream data determined by the packet processor.

8. A stream data processor comprising:
a buffer for storing stream data formed by a plurality of packets;
an execution unit for executing a first instruction program defining a process to output stream data with encoded input signal to the buffer and a second instruction program defining a process to generate a packet header and insert the packet header to the stream data; and
a boundary detector for detecting an insertion position of the packet header to the stream data,
wherein the boundary detector generates an interruption request to the execution unit in response to the detection of the inserting position of the packet header, and
the execution unit branches from the first instruction program to the second instruction program in response to the interruption request and resumes the first instruction program after completing the second instruction program.
